(19) United States
(12) Patent Application Publication
(10) Pub. No.: US 2020/0176165 A1
(43) Pub. Date: Jun. 4, 2020

(54) DEVICE FOR DEMAGNETIZING FERROMAGNETIC MATERIALS

(71) Applicant: Albert MAURER, Grüt (CH)

(72) Inventor: Urs MEYER, Niederglatt (CH)

(73) Assignee: Albert MAURER, Grüt (CH)

(21) Appl. No.: 16/204,075

(22) Filed: Nov. 29, 2018

(51) Int. Cl. H01F 13/00

(52) U.S. Cl. CPC H01F 13/006

(57) ABSTRACT

A particularly useful, technically robust, simply constructed and energy-saving device generating a magnetic field of alternating polarity by means of a current-carrying coil for the demagnetization of ferromagnetic materials.

### FIELD OF THE DISCLOSURE

The disclosure relates to a device for demagnetizing ferromagnetic materials.

### BACKGROUND

To demagnetize ferromagnetic materials, magnetic fields of alternating polarity with a gradually decreasing amplitude are used. These magnetic fields are generated by means of conductive coils (hereinafter briefly referred to as coils) through which an electric current in accordance with the desired strength of the magnetic field is passed. The gradually decreasing amplitude of the magnetic field is generated by appropriately controlling the magnitude of the current. This generates a time-varying magnetic field to which the material to be demagnetized is exposed. Alternatively, a time-constant magnetic field of continuously alternating polarity is used in which the material to be demagnetized is moved from the region of maximum field strength into the field-free region.

### SUMMARY

The present invention relates to an especially useful, technically robust, simply constructed and energy-saving device for generating a magnetic field by means of a current-carrying coil.

### BRIEF DESCRIPTION OF THE DRAWINGS

FIG. 1 shows a schematic diagram of a prior-art system for energizing a magnetic coil at a fixed frequency and a variable voltage.

FIG. 2 shows a schematic diagram for energizing a magnetic coil by means of a voltage source in a series oscillator circuit.

FIG. 3 shows a schematic diagram for energizing a magnetic coil by means of a pulse switched capacitor in a parallel oscillator circuit.

FIG. 4 shows the circuit for the energizing of a magnetic coil at the resonant frequency by means of bipolar supply.

FIG. 5 shows the circuit for automatic control at the resonant frequency.

FIG. 6 shows the circuit for energizing a magnetic coil at the resonant frequency by means of unipolar supply, magnetic coil with center tap.

FIG. 7 shows the circuit for energizing a magnetic coil at the resonant frequency by means of unipolar supply, via a bridge circuit for the switching elements.

### DETAILED DESCRIPTION

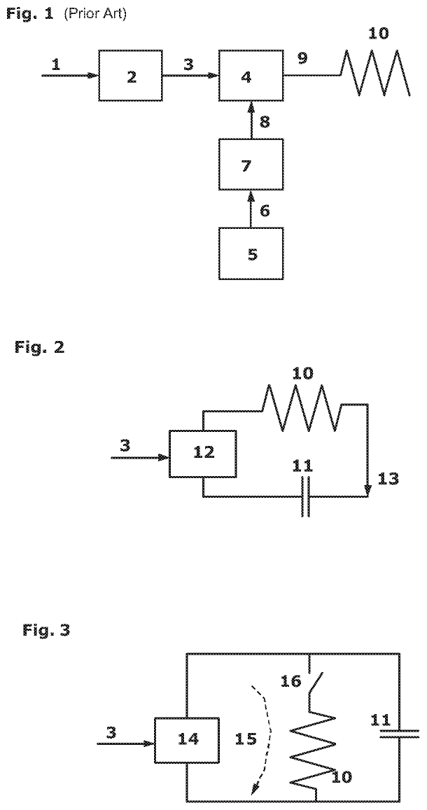

FIG. 1 shows a schematic diagram of a prior-art device for generating a magnetic field such as is used to demagnetize a ferromagnetic material. The line voltage 1 is fed to a rectifier 2 which supplies a DC intermediate circuit 3. A power amplifier 4 generates the voltage 9 necessary to energize the coil 10. A setpoint signal 8 generated by an oscillator circuit 7 is supplied to the power amplifier. This oscillator circuit generates a sinusoidal signal at a fixed frequency and an adjustable amplitude. The envelope curve with adjustable. This system is identical to a frequency converter known from the prior art. It is currently used for the demagnetization with a time-constant magnetic field of predefined frequency and amplitude. For demagnetization with a time-varying magnetic field, a sinusoidal setpoint signal 8 for the voltage 9 is supplied to the power amplifier 4. This setpoint signal 8 is generated by an oscillator circuit 7. The amplitude of the setpoint signal 8 follows in pulsed fashion the temporal profile of an envelope curve which is generated by the control unit 5 as the amplitude setpoint value 6.

This type of system can be implemented by means of an industrial frequency converter or an inverter for drives with induction motors by adding a control unit that is customized for the intended purpose.

One of the disadvantages of this solution is that, from the standpoint of process engineering, the system is undesirable in that the inductance varies with the charging of the coil. The current flowing through the coil and the magnetic field generated thereby are only imprecisely determined by the applied frequency and voltage. But an even more significant drawback is the reactive current requirement of such a circuit. The power circuit must supply this reactive current and must therefore be designed for the apparent power of the coil. This necessarily entails high circuit losses. Finally, commercially available frequency converters are invariably designed for the supplying three-phase voltage such as is required for industrial motors. For energizing a demagnetizing coil, however, only single-phase voltage is used. Thus, for use for this purpose, commercially available frequency converters have redundant elements and their design is unnecessarily complex. They are used for demagnetization purposes as described in the white paper “Entmagnetisieren von grossflächigen Objekten als Prozessvorbereitung vor Schweissverfahren [Demagnetizing large-surface objects in preparation for welding],” pages 3 and 9, published by Maurer Magnetic AG.

The disadvantage of the inadequately utilized circuit associated with the reactive current requirement of the coil can be eliminated by generating this reactive current by means of a capacitor. A basic configuration thereof is shown in FIG. 2. A capacitor 11 is connected in series to the coil 10 and thus creates a series oscillator circuit. A voltage source 12, usually a frequency converter, which is supplied with current by a direct current intermediate circuit 3, supplies the operating voltage to the series oscillator circuit. It is, in turn, inserted into the series-connected coil 10 and capacitor 11. As is known from the prior art, the resulting current 13 depends on the balance between the excitation frequency and the resonant frequency of the oscillator circuit. This is must be considered a disadvantage since this resonant frequency is dependent on the concentration of ferromagnetic material in the coil 10. This effect is utilized in a process described in CH698521. By tuning the excitation frequency on a flank of the oscillator circuit, it is possible to shift the operating point in targeted fashion as a function of the amount of ferromagnetic material in the direction of the resonance point. Thus, as the amount of ferromagnetic material increases, the efficacy of the overall device improves.

This type of solution requires a targeted deviation between the excitation frequency and the resonant frequency of the oscillator circuit and causes a loss of efficiency of the entire circuit.

In principle, it is also possible to operate the oscillator circuit formed by the coil 10 and the capacitor 11 as a parallel oscillator circuit. This is shown in FIG. 3. A current source 14, which is supplied by the DC intermediate circuit 3, charges the capacitor while the switch 16 is switched off. Once the voltage 15 has reached its target value, the current source 14 switches off and the switch 16 is closed. The oscillator circuit formed by the coil 10 and the capacitor 11 now at its resonant frequency. An example of a typical application of this type of circuit is the demagnetization of color picture tubes for television sets such as is described in U.S. Pat. No. 4,599,673. This circuit concept, which is also described in EP 0 021 274, is used for application purposes. However, its performance is insufficient for the demagnetization of industrial components and products made of modern steels. In a freely decaying oscillator circuit, the amplitude of the current falls too quickly to produce a qualitatively satisfactory demagnetization result. EP 0 282 290 discloses a circuit for demagnetizing TV picture tubes, which slows down this decay of the oscillations by periodically connecting a second capacitor to the circuit. As the aforementioned patent indicates, this is associated with an asymmetry in the amplitude profile of the demagnetizing current. However, such an asymmetry precludes the reliability of the demagnetization process.

The device described below is based on the concept that the oscillator circuit described is not supplied by means of an alternating voltage or alternating current source, but that its energy losses are compensated for by means of a circuit which acts as a negative resistor. Such an oscillator circuit always operates at the resonance point. Thus, at any given time, the resonant frequency continuously and directly follows the inductance of the coil. The influence of the quantity of ferromagnetic material in the coil is immediately compensated for by adjusting the frequency. The circuit always operates at optimum efficiency. This also means that the required components of the circuit are optimally utilized and optimally effective in the demagnetizing process.

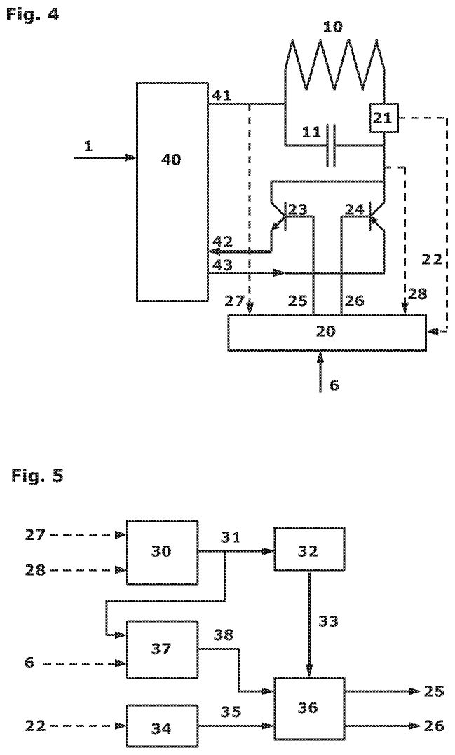

FIG. 4 illustrates the configuration of this type of circuit. In a bipolar supply circuit 40, the line voltage 1 is converted into a positive DC voltage 42 and a negative DC voltage 43 with a common center point 41. This center point is connected to a pole of the oscillator circuit formed by the coil 10 and the capacitor 11. The other pole of the oscillator circuit is connected to two power switches 23 and 24, which in the diagram are represented by a transistor symbol. The voltage of the oscillator circuit is measured at both poles as measured value 27 (actual value for the oscillator circuit voltage on the supply side) and 28 (actual value for the oscillator circuit voltage on the switching side). The current flowing in the oscillator circuit is tapped by means of a shunt 21 as the actual current signal 22. The N-power switch 23 connects the oscillator circuit to the negative supply voltage 42, and the P-power switch 24 connects the oscillator circuit to the positive supply voltage 43. The semiconductor elements inserted in the two line switches can be bipolar transistors, Darlington transistors, insulated-gate bipolar transistors or field-effect transistors. Their switching on and off is controlled by the signals 25 and 26. The control circuit 20 generates these two signals 25 and 26 in accordance with the oscillator circuit voltage, which is derived from the measured values 27 and 28, the oscillator circuit current, which is derived from the measured value 22, and the setpoint value 6 for the amplitude of the oscillator circuit voltage.

The operation of the control circuit 20 of FIG. 4 is illustrated in FIG. 5. A differential amplifier 30 determines from the measured values 27 and 28 an actual value signal 31 for the oscillator circuit voltage 31. The threshold switch 32 uses this actual value signal to form a digital signal 33 with the two values: 1 for the positive oscillator circuit voltage, and 0 for the negative oscillator circuit voltage. A threshold switch 34 converts the actual value current signal 22 into a digital signal 35 with the two values: 1 for positive current flow, and 0 for negative current flow. A voltage regulator 37 uses the amplitude setpoint value 6 and the actual value signal 31 to form a digital timed control signal 38. The switching logic circuits 36 determines the control signals 25 and 26 for the two power switches from the statuses of the signals 33, 35 and 38. This is implemented as follows: the P-power switch 24 is switched on once the oscillator circuit voltage exceeds zero in the positive direction (the digital signal 33 goes from 0 to 1). This power switch then follows the time given by signal 38 and switches off as soon as the current crosses zero in the negative direction (the digital signal 35 goes from 1 to 0). The N-power switch 23 is switched on once the oscillator circuit voltage exceeds zero in the negative direction (the digital signal 33 goes from 1 to 0). This power switch then follows the time given by signal 38 and switches off once the current crosses zero in the positive direction (the digital signal 35 goes from 0 to 1). In this manner, the oscillator circuit losses are compensated for in that phase-dependent current is supplied in controlled amounts. The effect of the circuit is equivalent to that of a negative resistor that is arranged in parallel with the oscillator circuit. The resulting frequency of the oscillation is equivalent of the natural resonant frequency determined by the values of the inductance of the coil and the capacitance of the capacitor. The amplitude of the oscillator circuit voltage can be controlled using the amplitude setpoint value 6.

FIG. 6 shows the circuit for energizing a magnetic coil at the resonant frequency with unipolar supply, magnetic coil with center tap. In a power supply circuit 44, the line voltage 1 is converted into DC voltage with a positive pole 45 and a negative pole 46. The positive pole 45 is connected to the center point of the coil 51 which, together with the capacitor 11, forms the oscillator circuit. The two poles of the oscillator circuit are each connected to one of the identical power switches 52 which in the diagram are represented by a transistor symbol. The voltage of the oscillator circuit is tapped at both poles as measured value 27 and 28 as actual values.

The current flowing in the oscillator circuit is measured by means of a shunt 21 as the actual current signal 22. The two power switches 52 connect the oscillator circuit to the negative pole 46 of the excitation voltage. The semiconductor elements inserted in the two line switches can be bipolar transistors, Darlington transistors, insulated-gate bipolar transistors or field-effect transistors. Their switching on and off is controlled by the signals 53, which are generated by the control circuit 50 using the mode of operation identical to that illustrated in FIG. 5. The particular advantages of this embodiment include the unipolar supply and the fact that the two power switches are identical.

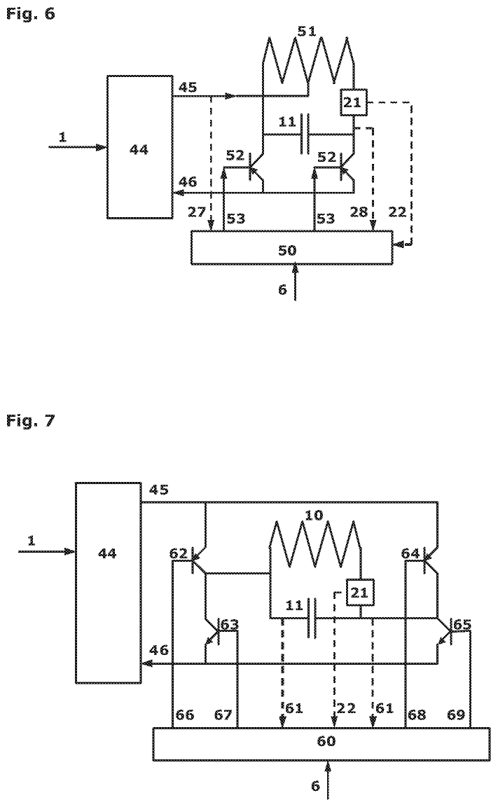

FIG. 7 shows the circuit for energizing a magnetic coil at the resonant frequency with unipolar supply and control via a bridge circuit. In a power supply circuit 44, the line voltage 1 is converted into a DC voltage with a positive pole 45 and a negative pole 46. This supply voltage reaches a bridge circuit known from frequency converters and servo amplifiers, which is formed by the power switches 62, 63, 64, 65. The coil 10 and the capacitor 11 form the oscillator circuit. The two poles of the oscillator circuit are located in the diagonal of the aforementioned bridge circuit. The oscillator circuit voltage is transmitted to the control circuit by means of the two voltage taps 61. The current flowing in the oscillator circuit is measured by means of a shunt 21 as the actual current signal 22. The entire bridge circuit is preferably configured in the form of an integrated module. The switching on and off of the individual bridge branches is triggered by the signals 66, 67, 68, 69 which are generated by the control circuit 60 using the mode of operation identical to that illustrated in FIG. 5. The use of a power circuit that is configured in the form of an integrated module is the particular advantage of this embodiment.

| Reference No. | FIG. | Name |
|---|---|---|
| 1 | 1, 4, 6, 7 | Power line supply |
| 2 | 1 | Rectifier |
| 3 | 1 | DC intermediate circuit |
| 4 | 1 | Power amplifier |
| 5 | 1 | Envelope curve generator |
| 6 | 1 | Amplitude setpoint value |
| 7 | 1 | Oscillator circuit |
| 8 | 1 | Setpoint signal |
| 9 | 1 | Coil voltage |
| 10 | 1 | Demagnetizing coil |
| 11 | 2 | Oscillator capacitor |
| 12 | 2 | Voltage source |
| 13 | 2 | Coil current |
| 14 | 3 | Current source |
| 15 | 3 | Coil voltage |
| 16 | 3 | Switch |
| 20 | 4 | Control circuit |
| 21 | 4, 6, 7 | Shunt |
| 22 | 4, 5, 6, 7 | Actual current signal |
| 23 | 4, 6, 7 | N-power switch |
| 24 | 4, 7 | P-power switch |
| 25 | 4, 6, 7 | Control signal for the N-power switch |
| 26 | 4, 6, 7 | Control signal for the P-power switch |
| 27 | 4, 5, 6 | Actual voltage of oscillator circuit on |
| | | supply side |
| 28 | 4, 5, 6 | Actual voltage of oscillator circuit on |
| | | switching side |
| 30 | 5 | Differential amplifier |
| 31 | 5 | Oscillator circuit voltage, actual signal |
| 32 | 5 | Threshold switch, zero voltage |
| 33 | 5 | Polarity signal, voltage |
| 34 | 5 | Threshold switch, zero current |
| 35 | 5 | Polarity signal, current |
| 36 | 5 | Switching logic |
| 37 | 5 | Voltage regulator |
| 38 | 5 | Timed control signal |
| 40 | 4 | DC voltage source, bipolar |
| 41 | 4 | Supply voltage, center point |
| 42 | 4, 6, 7 | Supply voltage, negative |
| 43 | 4, 6, 7 | Supply voltage, positive |
| 44 | 6, 7 | DC voltage source, unipolar |
| 45 | 6, 7 | Supply voltage, positive pole |
| 46 | 6, 7 | Supply voltage, negative pole |
| 50 | 6 | Control circuit |
| 51 | 6 | Coil with center tap |
| 52 | 6 | NPN Power switch |
| 53 | 6 | Control signal for the power switch |
| 60 | 7 | Control circuit |
| 61 | 7 | Voltage tap on the coil |
| 62, 63, 64, 65 | 7 | Power element in bridge circuit |
| 66, 67, 68, 69 | 7 | Control signal for the power element |

What is claimed is:

1. A device for demagnetizing ferromagnetic materials, comprising an inductance in the form of a magnetic coil and a capacitance, which together form an electric oscillator circuit, and a circuit for supplying electric energy, wherein the oscillation of voltage and current prevailing in the oscillator circuit is established and maintained automatically and exclusively at the resonance frequency.

2. The device according to claim 1, wherein the circuit for supplying electric energy is temporally controlled by the voltage and current values prevailing in the oscillator circuit.

3. The device according to claim 2, wherein the circuit for supplying electric energy to the oscillator circuit is regulated to a predefined setpoint value of the alternating voltage in the oscillator circuit.

4. The device according to claim 2, wherein the circuit for supplying electric energy to the oscillator circuit is regulated to a predefined setpoint value of the alternating current in the oscillator circuit.

5. The device according to claim 1, wherein energy is supplied to the oscillator circuit by the temporally controlled connection of an external voltage source.

6. The device according to claim 1, wherein energy is supplied to the oscillator circuit by the temporally controlled connection of an external current source.

7. The device according to claim 5, wherein the voltage source that supplies the energy is alternatingly switched in two polarities.

8. The device according to claim 5, wherein the circuit that supplies the energy operates with a bipolar voltage source, and wherein the two polarities are alternatingly switched by two switching elements.

9. The device according to claim 5, wherein the coil that forms the oscillator circuit is provided with a center tap, and wherein the circuit that supplies the energy operates with a monopolar voltage source and alternatingly supplies the two end terminals of the coil.

10. The device according to claim 5 using a monopolar voltage source, wherein the circuit that supplies the energy is configured in the form of a bridge circuit so that the sourced current is alternatingly supplied in both directions to the oscillator circuit.
